(19) United States
(12) Patent Application Publication
(10) Pub. No.: US 2011/0262729 A1
(43) Pub. Date: Oct. 27, 2011

(54) FUNCTIONALIZATION OF NANOSCALE FIBERS AND FUNCTIONALIZED NANOSCALE FIBER FILMS

(75) Inventors: I-Wen Chen, Xitun Dist. (TW); Zhiyong Liang, Tallahassee, FL (US); Ben Wang, Tallahassee, FL (US); Chun Zhang, Tallahassee, FL (US)

(73) Assignee: Florida State University Research Foundation, Tallahassee, FL (US)

(21) Appl. No.: 13/044,706

(22) Filed: Mar. 10, 2011

Related U.S. Application Data
(60) Provisional application No. 61/312,563, filed on Mar. 10, 2010.

(51) Int. Cl. B32B 3/26; C08J 3/28; B82Y 40/00; B82Y 30/00; B82Y 99/00

(52) U.S. Cl. 428/221; 522/113; 977/752; 977/750; 977/751; 977/847

(57) ABSTRACT

This disclosure provides articles that include functionalized nanoscale fibers and methods for functionalizing nanoscale fibers. The functionalized nanoscale fibers may be made by oxidizing a network of nanoscale fibers, grafting one or more molecules or polymers to the oxidized nanoscale fibers, and cross-linking at least a portion of the molecules or polymers grafted to the oxidized nanoscale fibers. The functionalized nanoscale fibers may be used to make articles.

### CROSS-REFERENCE TO RELATED APPLICATIONS

Priority is claimed to U.S. Provisional Application No. 61/312,563, filed Mar. 10, 2010. The provisional application is incorporated herein by reference.

### BACKGROUND

This disclosure relates generally to nanoscale fibers, and more particularly to methods for functionalizing carbon nanotubes or other nanoscale fibers to increase or improve the properties of the nanoscale fibers in buckypapers.

Since being discovered in 1991, carbon nanotubes (CNTs) have been the subject of many studies due to their unique mechanical and electronic properties. Recently, CNT macroscopic assemblies, such as thin films of nanotube networks or buckypapers (BPs) and nanotube fibers, have drawn much attention due to the potential to utilize the characteristic properties of individual CNTs in macroscopic scale samples and products. In particular, CNT assemblies may be used to fabricate organic electronic devices, hybrid solar cells, super capacitors, transparent electrodes, chemical sensors, field emission displays, artificial muscles, high-surface-area electrodes, and high-performance nanotube-reinforced composites.

However, the actual performance of macroscopic assemblies of CNTs, such as electrical conductivity and mechanical strength, have not been as high as expected. For example, most nanotube thin films and BPs have electric conductivity values ranging from 10-1000 Scm⁻¹, which is much lower than that of an individual CNT (10,000-30,000 Scm⁻¹ or higher). The lower conductivities observed for single-walled carbon nanotube (SWCNT) films may be due to the lack of alignment and short nanotube lengths, resulting in high contact resistances and Schottky barriers at inter-tube junctions. Bulk resistance of CNT network films may be dominated by contact resistance among nanotubes or their ropes in BP networks, which are one or two orders lower than the intrinsic conductivities of individual nanotubes. Several models have been developed to explore the effects of length, diameter and chirality on contact-resistance-dominated electrical properties of CNT networks.

The introduction of chemical covalent bonding and charge moieties between CNTs may enhance both the electric conduction and mechanical properties as compared to those CNTs assembled by weak van der Waals interactions. Chemical modification treatments of CNTs, such as acid treatment, oxidation, and plasma etching have been reported to produce functional groups (e.g., carboxylic acid, quinone, phenol, ester, amide and zwitterions) on oxidized SWCNTs at their end caps and at defect sites on their surface. Oxidations can also occur during SWCNT purification by HNO₃ oxidization when HNO₃ is used to remove surfactant at CNT junctions. These functional groups may enhance CNT interactions and charge-carrying capability.

The conductivity of acid-treated CNT film conductivity can be enhanced, resulting in the addition of charge carriers either in the form of p-type or n-type doping. Acid doping methods convert the semiconducting CNTs into metallic materials through effective tuning of the nanotubes' Fermi level by either changing the conduction or valance bands with electron doping or hole doping, respectively. Previously, CNT Fermi levels have been tuned by chemical treatment, thereby increasing the intrinsic conductivity of the SWCNTs while decreasing the inter-tube resistance of the semiconducting-metallic junction through mitigation of Schottky barrier. In addition, SWCNT films have showed relatively high conductivity after being treated with strong acids such as HNO₃. It also has been demonstrated that the amount of p-dope SWCNTs can be significantly increased by adjustment of the Fermi level of the valance bands using a HNO₃ treatment. For instance, Bower et al. observed intercalation of HNO₃ within a SWCNT network (Bower, C. et al. CHEM. PHYS. LETT. 1998, 288, 481-486). Yu and Brus have showed that the tangential mode of metallic SWCNTs in Raman scattering measurements depends on the exposure to a HNO₃ oxidization reaction (Yu, Z. and Brus, L. E., J. PHYS. CHEM. A. 2000, 104, 10995-10999). Those findings are attributed to charge transfer doping by acid treatments.

However, the doping effects of HNO₃ have been shown to be reversible, leading to questions regarding the overall stability of the enhancements of doped films for real engineering applications. In device and composite fabrication processes, doped CNT films of chemical treatments may go through polymeric resin impregnation and curing, metal deposition, and device encapsulation processes, for example. These steps may involve exposures to various solvents and open air, as well as elevated temperature conditions. Furthermore, actual device operation may also need the doped CNT films to work in open air and elevated temperatures. Therefore, doping stability is an issue for those treatments. Previously, researchers have used a polymer coating layer to protect doped CNTs and demonstrated an improved stability. Hence, it is important to have CNT films with high electrical conductive properties and doping stability when exposure to open air and/or elevated temperature conditions are required or expected.

Chemical polymerization of CNTs with carboxylic groups by a condensation reaction has been previously described. Ester bonds can be synthesized by a dehydration condensation reaction of a carboxylic group with a hydroxyl group in the presence of a dehydration-condensation-coupling agent. The ester structures can be further grafted onto a CNT surface by employing a dehydration condensation reaction called esterification. This reaction is also useful in grafting chemical molecules onto a CNT surface to conduct further derivative reactions to realize cross-linked nanotubes, such as polymerization reaction by using UV irradiation. The local coalescence and cross-link polymerization of CNTs using chemical treatment with thermal heating or UV irradiation resulted in the generation of vacancies on the nanotubes, which can improve carbon nanotube electrical property, and also improved the mechanical property. Irradiation cross-linked nanotubes have also been reported for improved electrical and mechanical properties of CNT networks. Recently, it also has been reported that thiol-functionalized multi-walled carbon nanotube (MWCNT) was used to facilitate CNT cross-linking. These CNT cross-links usually have high doping stability due to covalent bonding; however, the lack of designated conductive paths for charge-transfer improvement leads to only marginal improvement in electrical conductivity.

Therefore, it would therefore be desirable to develop CNT networks with high doping stability and designated charge-transfer paths to overcome contact resistances.

### BRIEF SUMMARY

In one aspect, methods are provided for functionalizing nanoscale fibers. In one embodiment, the method generally comprises oxidizing nanoscale fibers, grafting a molecule to the oxidized nanoscale fibers, and cross-linking at least a portion of the grafted molecules. In other embodiments, the method generally comprises oxidizing nanoscale fibers, grafting polymers to the oxidized nanoscale fibers, and cross-linking at least a portion of the grafted polymers. In certain embodiments, the nanoscale fibers may be cross-linked by irradiation, or by contacting the nanoscale fibers with a chemical agent having two or more reactive functional groups.

In another aspect, articles of manufacture are provided which comprise functionalized nanoscale fibers. The functionalized nanoscale fibers may be functionalized by a method described herein.

### BRIEF DESCRIPTION OF THE DRAWINGS

FIG. 1 is a schematic diagram for 1,4-addition polymerization reaction of diacetylenes.

FIG. 2 is a schematic illustration of a CNT conjunctional cross-linking process during ultra-violet (UV) irradiation, according to an embodiment described herein.

FIG. 3 depicts scanning electron microscope (SEM) micrographs of (a) a surface of a pristine multi-walled carbon nanotube bucky paper (MWCNT BP), and (b) a surface of cross-linked multi-walled carbon nanotube bucky paper (CCL-MWCNT BP) after irradiation with UV.

FIG. 4 depicts Raman spectroscopy data for tangential modes for (a) pristine MWCNT BP (top) and CCL-MWCNT-BP (bottom), and (b) pristine single-walled carbon nanotube bucky paper (SWCNT BP) (top) and cross-linked single-walled carbon nanotube (CCL-SWCNT-BP) (bottom).

FIG. 5 depicts the Fourier transform infrared (FT-IR) spectra of neat MWCNT-BP (top), films of MWCNT acid treated for 8 hrs. (middle), and CCL-MWCNT-BP after UV-irradiation (bottom).

FIG. 6 depicts the thermogravimetric analyses (TGA) in N₂ of pristine BP (top solid line, bottom dashed line) and cross-linked BP (top solid line, bottom dashed line) for (a) MWCNT BP, and (b) SWCNTs BP; weight loss (wt %, solid lines) and differential weight loss (wt %/dT, dashed lines) as a function of temperature.

FIG. 7 is a depiction of BP Resistance Variation/% for (a) MWCNT BP versus time in air for CCL-MWCNT-BP (black square) and acid-treated MWCNT BP (hollow square), and (b) BP resistance of SWCNT BP versus time in air for CCL-SWCNT-BP (black square) and acid-treated SWCNT BP (hollow square).

FIG. 8 is a depiction of BP Resistance Variation/% for (a) MWCNT BP versus temperature for BP with (black square) and without (hollow square) cross-linking, and (b) BP resistance increase of SWCNT BP versus temperature for BP with (black square) and without (hollow square) cross-linking; hollow squares indicate BP treated with nitric acid, black squares indicate CCL-BP.

FIG. 9 is a depiction of tensile stress-strain curves of (a) a random MWCNT BP (dot line) and CCL-random MWCNT-BP (solid line); (b) an aligned MWCNT-BP (dot line) and CCL-aligned MWCNT-BP (solid line); and (c) a SWCNT BP (dot line) and CCL-SWCNT-BP (solid line).

### DESCRIPTION OF THE INVENTION

Methods have been developed to functionalize nanoscale fibers, networks of nanoscale fibers, and nanoscale fibers in nanoscale fiber films.

In one aspect, a method is provided to conjugationally cross-link nanoscale fibers (e.g., CNTs) to achieve high electrical conductivity and doping stability in CNT networks or thin films. In one embodiment, CNTs are contacted with HNO₃ and then a polydiacetylene (PDA) molecule to create CNT cross-links with higher charge transfer capability. BPs produced by such a method may have greater electrical conductivity, doping stability, and/or mechanical properties.

The conjugational cross-linked BPs (CCL-BPs) produced by the methods described herein may demonstrate high electrical conductivity; for example, up to 6200 Scm⁻¹, which is more than one order greater than the electrical conductivity of pristine BP. Without being bound by a particular theory, the mechanism of the electrical conductivity increase is believed to be the increasing inter-tube electron transport capability. The conjugational cross-links may provide effective conductive paths to increase the mobility of electrons among individual nanotubes. Unlike other chemical doping methods, some CCL-BP samples advantageously have a doping stability of over 300 hrs in an ambient atmosphere, and are generally resistant to degradation at elevated temperatures.

In addition, the cross-links may improve the mechanical properties of the BP materials. While not wishing to be bound by any particular theory, these improvements may be the result of effective and stable conjugational cross-linking of CNTs, which can improve BP electrical conductivity, doping stability, and/or mechanical properties for their potential use in engineering applications of macroscopic assemblies or networks of CNTs.

### Functionalizing Nanoscale Fibers

Methods for functionalizing a network of nanoscale fibers are provided. In one embodiment, the method comprises contacting the network of nanoscale fibers with an acid, contacting the network of nanoscale fibers with a conjugated polymer to graft the conjugated polymer to at least a portion of the nanoscale fibers, and irradiating the nanoscale fiber film. The radiation, e.g. UV, cross-links at least a portion of the conjugated polymer grafted to the nanoscale fibers. In another embodiment, a chemical agent with two, three, or more than three, reactive functional groups may be used to react with other agents to form cross-link structures. In some embodiments, the radiation reaction is preferred for PDA-type molecule curing due to its high efficiency.

Examples of suitable acids for use in the method include nitric acid, sulfuric acid, and hydrogen chloride. Other acids and oxidants, such as m-chloroperoxybenzoic acid and benzoyl peroxide, may also be used.

### Conjugated Polymers

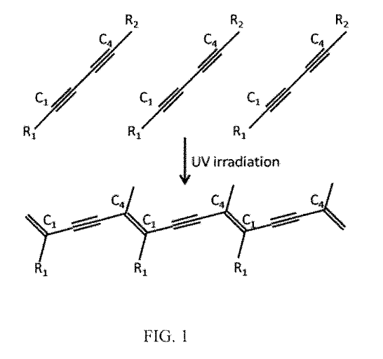

In certain embodiments, the conjugated polymer is selected from polydiacetylenes (e.g., 10,12-pentacosadiyn-1-OL (PCDO)). Polydiacetylenes (PDAs) are a family of highly π-conjugated polymers that have unique characteristics associated with their ability to self-assemble. An example of a PDA is shown in FIG. 1. The ene-yne backbone of PDA derivatives leads to optical and electrical properties associated with extensively delocalized π-electron networks and intrinsic conformational restrictions.

### The Carbon Nanotubes

As used herein, the terms “carbon nanotube” and the shorthand “nanotube” refer to carbon fullerene, a synthetic graphite, which typically has a molecular weight between about 840 and greater than 10 million. Carbon nanotubes are commercially available, for example, from Carbon Nanotechnologies, Inc. (Houston, Tex. USA), SouthWest NanoTechnologies, Inc. (Norman, Okla. USA), or Nanocomp Technologies, Inc. (Concord, N.H.) or can be made using techniques known in the art.

In one embodiment, the buckypaper is a thin film (approximately 20 μm) of nanotube networks, which can be utilized in various products, such as composites, electronic devices and sensors. Buckypapers or thin films may be made through the dispersion of nanotubes in suspension followed by a filtration or evaporation process, stretching or pushing synthesized nanotube “forests” to form sheets or strips, and the consolidation of syntheses nanotube aerogels to form film membranes.

The functionalized nanoscale fiber films may be used to fabricate highly conductive and stable nanoscale fiber sheet materials for both immediate and near future Micro Electra Mechanical Systems (MEMS) engineering, such as sensors, transistors, electrodes, actuators, fibers and composite applications requiring high conductivity and mechanical properties and thermal stability properties.

Composite materials are provided that comprises conjugationally cross-linked nanoscale fibers and a matrix material.

The methods and compositions can be further understood with the following non-limiting examples.

### Example 1

This example demonstrates the improved electrical conductivity and high doping stability of BP resulting from conjugationally cross-linking carbon nanotubes in the BP via chemical functionalization with ene-yne backbone molecules. Thin, randomly oriented and aligned nanotube sheets of millimeter-long multi-walled carbon nanotubes (MWCNT) manufactured by Nanocomp Technologies, Inc. (Concord, N.H.) were used to produce cross-linked samples. The aligned MWCNT had a small alignment degree (<20% alignment degree by Raman spectrum measurement). These BP sheets were mechanically strong, with a breaking strength of about 100 MPa, and displayed high electrical conductivity (about 400 S cm⁻¹). The SWCNTs used in this example were produced by Carbon Nanotechnologies, Inc. (CNI, Houston, Tex.). 10,12-pentacosadiyn-1-OL, (PCDO) material, one of the commercially available PDA molecules, and nitric acid was purchased from Sigma-Aldrich. The PCDO was dissolved in THF solvent, The concentration of PCDO is higher than 1 nM and the solution was kept in a dark vial to avoid undesired reactions with light. All the materials were used as received.

### Preparation of SWCNT Buckypaper

The SWCNT networks were prepared by a dispersion and filtration process. First, the SWCNT powders were ground with a few drops of water using a mortar and pestle. Then a bath sonication process (Sonicator 3000, Misonix, Inc.), was used for one hour to prepare a CNT suspension with the aid of an aqueous Triton X-100 surfactant. The suspension usually has 40 mg/L nanotube concentration and 400 mg/L surfactant content. The suspension was filtered through a PTFE membrane (pore size of 0.45 μm) under a 29 in Hg vacuum to produce randomly dispersed BP samples having a 10-20 μm thickness. The samples were washed repeatedly with distilled water and isopropanol to remove the surfactant. The BPs were annealed at 550° C. in argon gas for 4 hours to burn off the impurities and residual surfactant from the samples. The BP sheets had a breaking strength of about 15 MPa and an electrical conductivity of about 150 Scm⁻¹.

### Preparation of Conjugationally Cross-Linked CNT Films

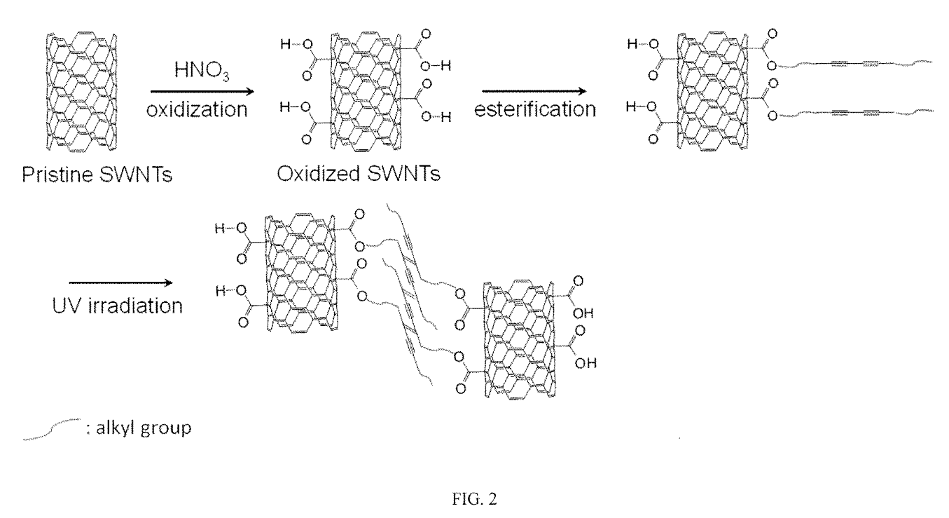

Chemical functionalization of the BPs using a 12 M nitric acid treatment was performed by immersing the BPs into the acid solution for 8 hrs. A doping time of 8 hrs was used because previous tests revealed no significant difference in the Raman spectra of films processed with immersion times increased from 10 hrs to 30 hrs. The treated films were washed and dried in air. Subsequently, the films were baked in an oven at 50° C. to further remove residues. The acid-treated films were immersed into the THF solution containing PCDO molecules for 2 hrs. Thus, the functionalized BPs with carboxylic acid groups reacted with PCDO to carry out esterification reactions, as shown in FIG. 2. After the esterification process, the films were washed with THF, and then blown dry. Esterified BP was subsequently treated with UV irradiation at the wavelength of 365 nm with a sample-source distance of approximately 2 cm in a nitrogen-purged dark chamber for 90 minutes. After polymerization via a 1,4-addition reaction, the CCL-BP samples were rinsed with THF and blown dry with a stream of nitrogen. The neighboring diactylenes (DAs) were polymerized via a 1,4 addition mechanism by UV irradiation without the need for chemical initiators or catalyst.

The conductivities of the BP samples were measured using a conventional four-probe method. A Keithley 6221 meter was used as a current source and a Keithley 2182 was used as a nano-voltmeter to obtain characteristics of current-voltage curves, and a Labview program was used to obtain a simultaneous voltage reading during current flow.

Thermal analysis of BP was performed using a thermogravimetry analysis (TGA; TA Instruments Q800). All TGA measurements were carried out under a nitrogen atmosphere flushed at 20 ml min⁻¹ and under a heating rate of 20° C. min⁻¹ from 50° C. to 1000° C.

The mechanical properties of pristine and cross-linked BP samples were tested using a Dynamic Mechanical Analysis machine (DMA Q800, TA Instruments) under controlled forced mode with stress-strain sweeping of 0.5 N min⁻¹ from 0 to 18 N. All BP samples had a dimension of 20 mm×3 mm.

Nanostructures of pristine and cross-linking BPs were characterized with a field-emission scanning electron microscope (FE-SEM) (JSM-7401F, JOEL Co.).

To deter mine the effects of acid treatment and cross-linking on the electrical stability of the BP samples, resistivity vs. air exposure time relationships were monitored. To measure the electrical stability property under thermal loading, BP samples were placed on a hot plate and heated to given temperatures, and their resistances were measured.

### Effect of Cross-Linking on Morphology, Raman and IR Spectra

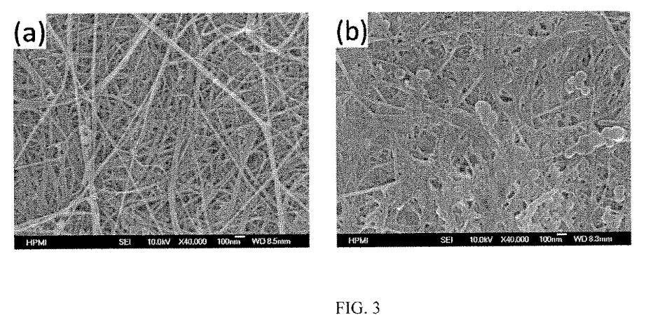

The surface morphology of the MWCNT sheets before and after cross-linking is shown in FIG. 3. The nanotube ropes can be seen on the surface of the pristine films, and the nanotubes were randomly oriented for both random and aligned samples due to limited alignment degree. The surface morphology after cross-linking was changed. Most nanotube ropes were wrapped up with the polymers due to the chemical cross-links.

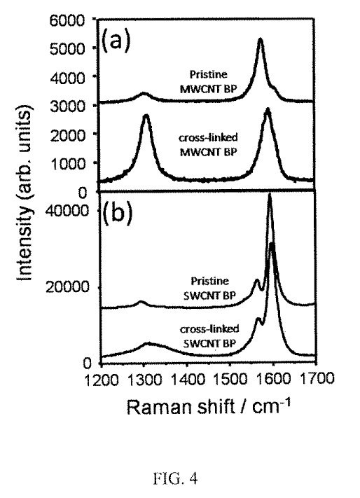

The Raman D-band (˜1300 cm⁻¹) to G-band (˜1590 cm⁻¹) intensity ratio (D/G ratio) was a good indication to confirm electronic structure changes of CNTs due to chemical functionalization. FIG. 4 shows the D and G band ranges of the Raman spectra of MWCNT and SWCNT samples before and after cross-linking processes. The cross-links introduced more SP³ hybrids on the functionalized CNTs and the disorder band (1300 cm⁻¹) became much larger as compared to the pristine carbon nanotubes. FIG. 4a shows that the D/G ratios of MWCNT BP before and after the cross-links were 0.18 and 0.85, respectively. In case of the SWCNT BP, there was a slight decrease in the intensity of the tangential vibration of the G band at 1590 cm⁻¹ with an increase of broad D band at around 1300 cm⁻¹, as shown in FIG. 4b, due to possible degradation of SWCNT stiffness.

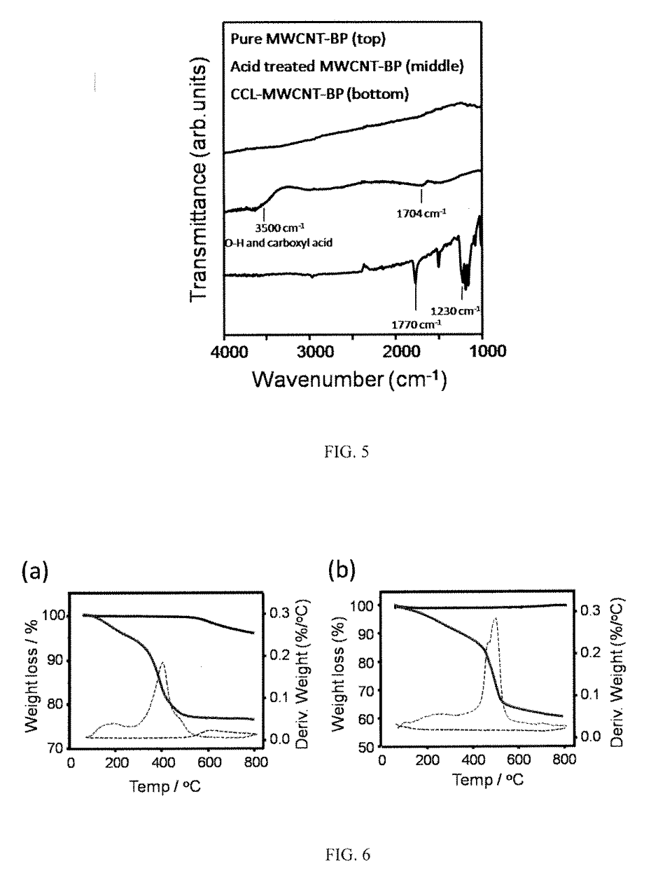

The presence of functional groups on the samples was identified using IR spectroscopy with a reflection method. The IR spectra of the pristine MWCNT BP, acid-treated MWCNT-BP, and cross-linked MWCNT-BP through the estherification reaction are shown in FIG. 5. In the case of acid-treated MWCNT BP (FIG. 5; middle), the small band at 1704 cm⁻¹ was assigned to the stretching vibration of the C═O carboxylic acid and carbonyl, while the bands at 3500 cm⁻¹ correspond to the stretching vibration of the O—H carboxyl, hydroxyl and phenolic groups. On the other hand, after the esterification procedure (FIG. 5; bottom), the peaks at 1100 to 1250 cm⁻¹ reflect the presence of stretching vibration modes of —C—O—C in the ester. The 1770 cm⁻¹ peak correlates with the stretching vibration of the C═O moiety in ester groups. Based on the IR spectrum analysis it can be proposed that the carboxylic acid and hydroxyl groups on the nanotube surface were created through acid treatment and then converted into ester bonds with the subsequently introduced PCDO molecule, and finally formed ester structures by an esterification reaction, as shown in FIG. 2. Thus, conjugational ester bonds in CCL-MWCNT-BP would provide cross-linking and electrons or charge transfer between nanotubes.

### Thermogravimetric Analysis (TGA).

TGA was employed to investigate thermal stability and PCDO concentration of the samples before and after cross-link functionalization. FIG. 6a compares the TGA profiles of pristine MWCNT BP (top solid line, bottom dashed line) and cross-linked BP (top solid line, bottom dashed line). The TGA curve of pristine MWCNT BP shows one degradation stage before the final decomposition of the MWCNT BR The TGA curve of CCL-MWCNT-BP shows three main degradation stages before the final decomposition of the CCL-MWCNT-BP. The first weight loss region, with about 4 wt. % loss of initial weight around 100-250° C., was due to the evaporation of water molecules or monomer molecules. It was believed that some uncross-linked monomers would absorb on the BP surface. The second weight loss region, with about 17.2 wt. % loss of initial weight around 250-560° C., was due to decomposition of cross-linked molecules. The differential TGA curve shows the CCL-MWCNT-BP having one peak at 400° C., which can be considered the decomposition temperature of cross-linked PCDO molecules. Hence, PCDO is about 18.3 wt. % in the CCL-MWCNT-BP sample.

FIG. 6b shows the TGA curves for pristine SWCNT (top solid line, bottom dashed line) and cross-linked BP (top solid line, bottom dashed line) samples. Decomposition occurred in two distinct steps for unreacted monomers and cross-linked PCDO molecules of cross-linked samples. The first decomposition was at around 100-350° C., probably representing the cleavage of unreacted cross-linked monomer. A second decomposition step was observed at around 350-600° C. for the cross-linked molecules. The differential TGA curve shows one peak for the CCL-SWCNT-BP at 490° C., which can be related to the decomposition temperature of cross-linked PCDO molecules within the BP. Here, the PCDO concentration was 24.0 wt. % of the CCL-SWCNT-BP. Much denser cross-linking networks may be formed on SWCNT-BP due to the large surface area and more reactive surface of SWCNT-BP samples. Therefore, CCL-SWCNT-BP possesses a higher decomposition temperature than CCL-MWCNT-BP.

### Effect of Conjugational Cross-Link Functionalization on Electrical Conductivity

The DC conductivity test values of all BPs are shown in Table 1.

TABLE 1
DC conductivity of BPs

| | DC conductivity (Scm⁻¹) | | |
|---|---|---|---|
| | Undoped | Acid-treated BPs | Cross-linked BPs |
| Random MWCNT | 400 | 1600 | 2380 |
| Aligned MWCNT | 600 | 2400 | 6200 |
| SWCNT | 150 | 330 | 550 |

The conductivity for these three types of pristine and acid-treated BPs was less than 2400 Scm⁻¹. It has been shown that acid treatments could enable Fermi-level shifting into the van Hove singularity region of metallic CNTs, resulting in a substantial increase in the density of states at the Fermi level. Hence, electrical conductivity values of all three BPs increased after the acid treatment. The electric conductivity values of all three CCL-CNT-BP samples were further increased to one and half times higher than that of the acid-treated BPs. This indicates that the conjugational cross-links of CNTs could have a conjugation system for electron transport to further increase electrical conductivity. Particularly, for the aligned MWCNT BP sample, conductivity increased by about 11 fold from 600 to 6,200 Scm⁻¹ as compared to the pristine BP at room temperature. Such a large conductivity increase was caused by the formation of conjugation of ene-yne backbone in the cross-links, thereby providing effective electron transfer paths within the CNT networks. But the SWCNT BP improvement of conductivity is not as much as the improvement in the MWCNT samples due to possible nanotube structure damage, which can significantly degrade SWCNT's intrinsic conductivity.

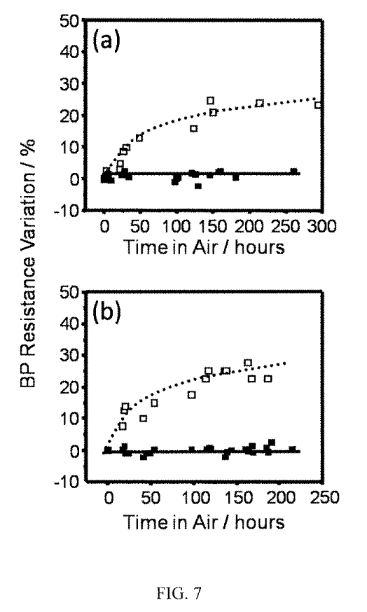

Effect of Conjugational cross-link functionalization on conductivity stability Conjugational cross-link structures, which eliminate or reduce the number of unpolymerized molecules, should have high conductivity stability. The effect of the cross-links in the BPs on the relationship between electrical conductivity stability and open-air exposure time is presented in FIG. 7. The MWCNT BPs with the nitric acid treatment showed a resistance increase of 23% after being exposed to open air for 300 hrs, while the CCL-MWCNT-BP showed no observable resistance changes under the same conditions. For the SWCNT-BPs with the nitric acid treatment, a 25% increase in resistance is shown after 200 hrs. Similarly, the CCL-SWCNT-BP samples only had less than a 5% resistance increase after 220 hrs, as shown in FIG. 7b. The resistance change of the nitric-acid-treated BP was proved to be easily reversible and degradable due to conductivity depending on the mobile HNO₃ and NOₓ residues intercalation within the network. In contrast, introducing a covalent bond with conjugated molecules to link individual carbon nanotubes eliminated mobile moieties. Hence, CCL-BP conductivity was very stable as compared to the acid-treated samples due to the designated conjugational cross-links providing stable and permanent electrical conducting paths through CNTs network.

### Thermal Stability of Conjugational Cross-Linked BPs

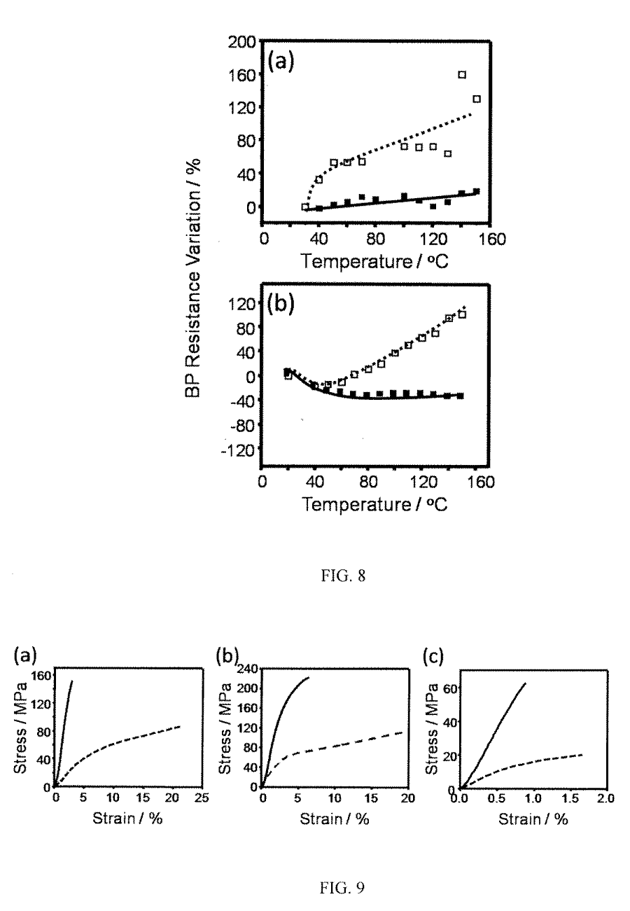

The thermal stability of the electrical conductivity of CCL-BPs was tested, since they may be used in elevated temperature environments. The results of the thermal stability experiments are shown in FIG. 8. Resistance variations of both acid treated BP and CCL-BP samples for temperatures ranging from 20 to 150° C. were measured. As shown in FIG. 8a, the electrical resistance of nitric-acid-treated MWCNT-BP increased with the increase of temperature. Previous research indicates that intercalated HNO₃ and nitrogen oxide immediately desorbs from CNT surface under thermal annealing at temperature greater than 320° C. This effect was observed at temperatures lower than 100° C., in which electrical resistance increased by up to 100%. In contrast, the CCL-MWCNT-BP showed no change in electrical resistance at temperatures up to 150° C. Thus, the CCL-BP showed the thermal stability after exposure to elevated temperatures.

### Mechanical Property Improvement

The tensile stress-strain curves of the acid-treated and CCL-BP samples are shown in FIG. 9.

FIG. 9a shows the tensile measurement of CCL-MWCNT-BP samples. The randomly oriented CCL-MWNCT-BP revealed that the average tensile strength was 150 MPa, which was two times stronger than that of the pristine samples. The Young's moduli of the randomly oriented pristine MWNT-BP and CCL-MWCNT-BP were 1.04 GPa and 10.18 GPa, respectively. The average elongation to break of both the randomly oriented and aligned pristine MWCNT-BPs was 20.0%, which was seven times higher than that for the CCL-MWCNT-BP samples. These results indicate an improvement in load transfer and less nanotube slippage after the cross-link reaction. The pristine BPs showed a noticeable plateau in the stress-strain curves and low mechanical properties due to CNT slipping and limited inter-tube interactions and load transfer. Cross-linking of CNTs was an effective approach to effectively eliminate sliding between the CNTs. FIG. 9b shows the tensile properties of the aligned CCL-MWCNT-BPs having improved mechanical and electrical properties. The tensile strength was 220 MPa, two times stronger than the tensile strength of pristine aligned MWCNT films. The Young's moduli of the pristine aligned BP and CCL-MWCNT-BPs were 1.91 GPa and 8.8 GPa, respectively. FIG. 9c shows the tensile properties of SWCNT-BP samples. The tensile strength of the CCL-SWCNT-BP was 65 MPa, which was four times stronger than the tensile strength of the pristine sample. The Young's moduli of the pristine and CCL-SWCNT-BP samples were 2.02 GPa and 8.6 GPa, respectively. The cross-links led to a seven fold increase in Young's modulus and a four fold increase in tensile strength for the CCL-SWNT-BP samples.

Modifications and variations of the methods and devices described herein will be obvious to those skilled in the art from the foregoing detailed description. Such modifications and variations are intended to come within the scope of the appended claims.

We claim:

1. A method for functionalizing a network of nanoscale fibers comprising:
contacting the network of nanoscale fibers with an acid or an oxidant, effective to oxidize at least a portion of the nanoscale fibers;
contacting the network of nanoscale fibers with a conjugated polymer to graft the conjugated polymer to at least a portion of the oxidized nanoscale fibers; and
cross-linking at least a portion of the conjugated polymer grafted to the at least a portion of the nanoscale fibers by irradiating the network of nanoscale fibers with an effective amount of radiation, or by contacting the network of nanoscale fibers with a chemical agent comprising two or more reactive functional groups.

2. The method of claim 1, wherein the network of nanoscale fibers comprises a nanoscale fiber film.

3. The method of claim 1, wherein the nanoscale fibers comprise MWCNTs, SWCNTs, or a combination thereof.

4. The method of claim 3, wherein the MWCNTs and/or SWCNTs are substantially in alignment.

5. The method of claim 1, wherein the network of nanoscale fibers is contacted with the acid.

6. The method of claim 5, wherein the acid comprises nitric acid, sulfuric acid, hydrogen chloride, m-chloroperoxybenzoic acid, or a combination thereof.

7. The method of claim 1, wherein the network of nanoscale fibers is contacted with the oxidant.

8. The method of claim 7, wherein the oxidant comprises a peroxide.

9. The method of claim 8, wherein the peroxide is benzoyl peroxide.

10. The method of claim 1, wherein the conjugated polymer comprises a polydiacetylene.

11. The method of claim 10, wherein the polydiacetylene comprises 10,12-pentacosadiyn-1-OL.

12. The method of claim 1, wherein the crosslinking is by irradiating and the radiation is UV radiation.

13. A method for functionalizing a network of nanoscale fibers comprising:
contacting the network of nanoscale fibers with an acid or an oxidant, effective to oxidize at least a portion of the nanoscale fibers;
contacting the network of nanoscale fibers with a conjugated polymer to graft the conjugated polymer to at least a portion of the oxidized nanoscale fibers; and
irradiating the network of nanoscale fibers with an amount of radiation effective to cross-link at least a portion of the conjugated polymer grafted to the at least a portion of the nanoscale fibers.

14. An article of manufacture comprising:
a network of nanoscale fibers, wherein at least a portion of the nanoscale fibers are cross-linked by a conjugated polymer or other molecule.

15. The article of claim. 14, wherein the conjugated polymer or other molecule comprises a polydiacetylene.

16. The article of claim 14, wherein the network of nanoscale fibers has an electrical conductivity of at least 6200 S cm⁻¹.

17. The article of claim 14, wherein the nanoscale fibers comprise MWCNTs, SWCNTs, or a combination thereof.

18. The article of claim 17, wherein the MWCNTs and/or SWCNTs are substantially in alignment.
